(19) United States
(12) Patent Application Publication
(10) Pub. No.: US 2011/0149435 A1
(43) Pub. Date: Jun. 23, 2011

(54) ABSORBING CONTAMINANTS BY DIFFUSION IN A LOW DENSITY GAS FILLED HARD DISK DRIVE (HDD)

(76) Inventor: Charles BROWN, San Jose, CA (US)

(21) Appl. No.: 12/642,016

(22) Filed: Dec. 18, 2009

(51) Int. Cl. G11B 33/14

(52) U.S. Cl. 360/97.02; G9B/33.035

(57) ABSTRACT

A hard disk drive (HDD) including a magnetic disk, a low density gas within the HDD and an absorber configured to absorb contaminants within the HDD by diffusion.

### BACKGROUND

Hard disk drives (HDD) typically include a flow-through filter configured to filter contaminants from air that is flowing through the flow-through filter. A sufficient airstream is derived within the HDD by momentum of air flow generated by a rotating disk. Consequently, the air stream flows through the flow-through filter. However, a low density gas (lower than air) within the HDD would provide less momentum and less stagnation pressure. Accordingly, significantly less gas would flow through the flow-through filter, which would result in significantly less contaminants captured by the flow through filter.

### BRIEF DESCRIPTION OF THE DRAWINGS

FIG. 1 illustrates an example of a HDD, in accordance with an embodiment of the present invention.

FIG. 2 illustrates an example of an absorber, in accordance with an embodiment of the present invention.

FIG. 3 illustrates an example of a flow chart of a method for absorbing contaminants within a low density gas filled HDD, in accordance with an embodiment of the present invention.

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

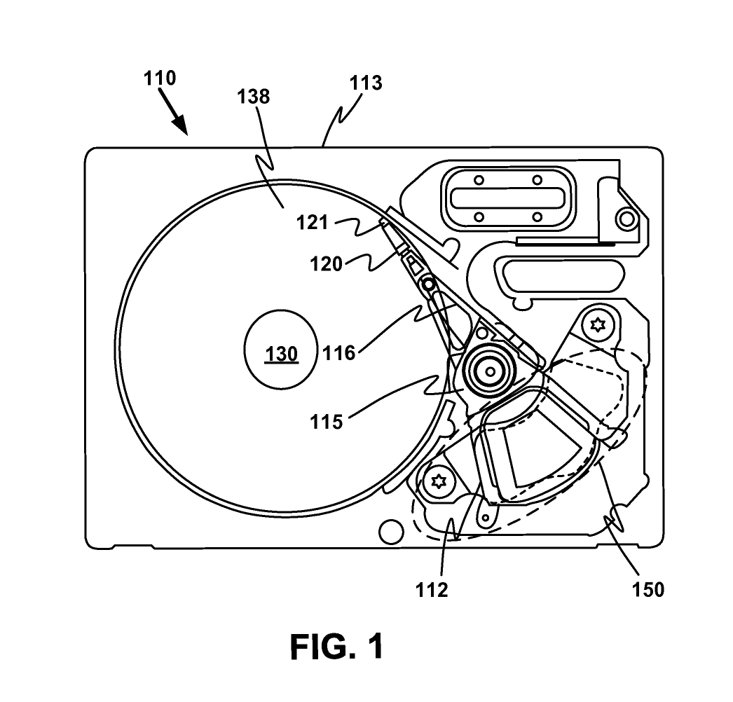

With reference now to FIG. 1, a schematic drawing of one embodiment of an information storage system including a magnetic hard disk file or HDD 110 for a computer system is shown, although only one head and one disk surface combination are shown. What is described herein for one head-disk combination is also applicable to multiple head-disk combinations. In other words, the present technology is independent of the number of head-disk combinations.

In general, HDD 110 has an outer sealed housing 113 usually including a base portion and a top or cover (not shown). In one embodiment, housing 113 contains a disk pack having at least one media or magnetic disk 138. The disk pack (as represented by disk 138) defines an axis of rotation and a radial direction relative to the axis in which the disk pack is rotatable.

A spindle motor assembly having a central drive hub 130 operates as the axis and rotates the disk 138 or disks of the disk pack in the radial direction relative to housing 113. An actuator assembly 115 includes one or more actuator arms 116. When a number of actuator arms 116 are present, they are usually represented in the form of a comb that is movably or pivotally mounted to base/housing 113. A controller 150 is also mounted to base 113 for selectively moving the actuator arms 116 relative to the disk 138. Actuator assembly 115 may be coupled with a connector assembly, such as a flex cable to convey data between arm electronics and a host system, such as a computer, wherein HDD 110 resides.

In one embodiment, each actuator arm 116 has extending from it at least one cantilevered integrated lead suspension (ILS) 120. The ILS 120 may be any form of lead suspension that can be used in a data access storage device. The level of integration containing the slider 121, ILS 120, and read/write head is called the Head Gimbal Assembly (HGA).

The ILS 120 has a spring-like quality, which biases or presses the air-bearing surface of slider 121 against disk 138 to cause slider 121 to fly at a precise distance from disk 138. ILS 120 has a hinge area that provides for the spring-like quality, and a flexing cable-type interconnect that supports read and write traces and electrical connections through the hinge area. A voice coil 112, free to move within a conventional voice coil motor magnet assembly is also mounted to actuator arms 116 opposite the head gimbal assemblies. Movement of the actuator assembly 115 by controller 150 causes the head gimbal assembly to move along radial arcs across tracks on the surface of disk 138.

Various functions of HDD 110 are affected by fluid dynamic properties of the gas/air that is sealed inside HDD 110. For example, if air is sealed within HDD, an air stream generated by rotation of disk 138 can cause substantial disk flutter. Moreover, the density of moving air within HDD can generate high power consumption. Also, air within HDD 110 provides substantial momentum which allows for sufficient air flow through a flow-through filter.

In general, flow-through filters allow intimate contact of gas flow through the filter to remove contaminants. In the case of vapor, a flow-through filter is dispersed in a way to allow such intimate contact, while attempting to minimize the resistance to the air flow created by the absorber.

A low density gas (e.g., helium) within HDD 110 generates less disk flutter as compared to air. In particular, a lower density gas results in less momentum imparted by rotating disks (as compared to air). A low density gas also reduces the energy available to force the low density gas through a flow-through filter.

For example, the density of helium is lower than the density of air. As such, as disk 138 rotates, helium within HDD 110 generates a lower momentum (as compared to air) and accordingly less gas flow, disk flutter, power consumption, etc. In various embodiments, low density gas (i.e., lower density than air) is helium, hydrogen or neon. It should be appreciated that low density gas includes a molecular weight lower than air.

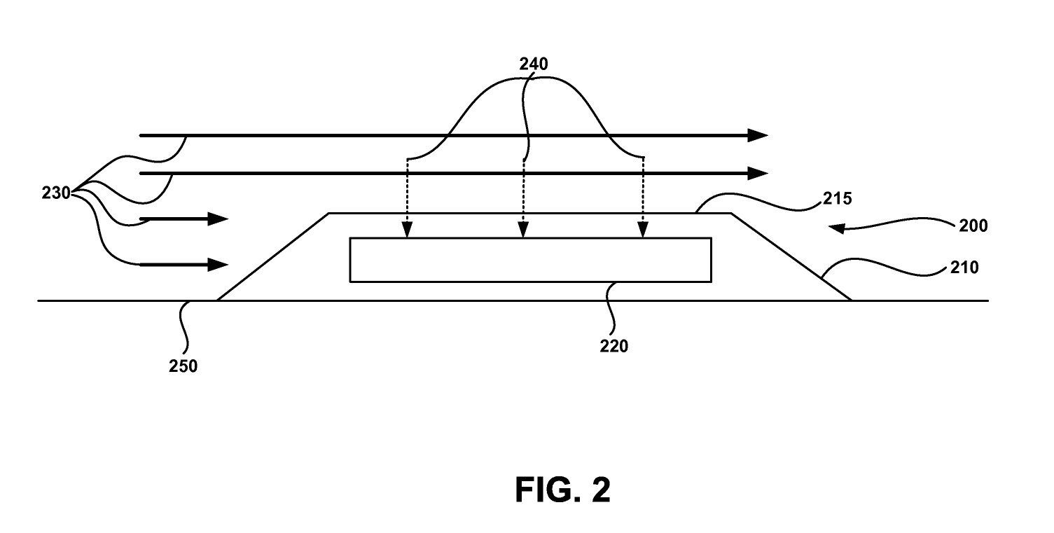

FIG. 2 illustrates an example of an absorber 200, in accordance to an embodiment. Absorber 200 is disposed within any area of HDD 110 where there is a gas stream. In one embodiment, absorber 200 is disposed in a location where it protrudes above surrounding physical features. In another embodiment, absorber 200 protrudes directly into gas stream 230. For example, absorber 200 is not placed within an indentation, pocket, recess or any location where there is little to no gas flow. In various embodiments, absorber 200 is disposed on surface 250 within HDD 110. It should be appreciated that absorber 200 is not required to be disposed proximate to an injection hole. It should also be appreciated that absorber 200 is attached to surface 250 by, but not limited, to adhesive.

Absorber 200 includes an absorbent 220 (e.g., carbon) surrounded by a porous material 210. As gas stream 230 (including contaminants) flows by absorber 200, a portion of gas (including contaminants) diffuses or migrates, across stream lines of gas stream 230 in the direction of arrows 240, into absorber 200. Accordingly, the contaminants (not shown) within the gas flow are absorbed by absorber 200 via absorbent 220. As gas stream 230 continually flows by absorber 200, gas continually diffuses in the direction of arrows 240 into absorber 200 and contaminants are continually absorbed within absorber 200 via absorbent 220. In one embodiment, gas stream 230 is a column of gas that moves in intimate contact smoothly over the surface 215 of absorber 200.

Gas stream 230 is generated by rotating disk(s) inside HDD. Contaminants can diffuse into absorber 200 even when disk(s) within HDD are not rotating. It should be appreciated that efficiency of function is considerably reduced when the disks are not spinning, because the contaminant concentration in proximity to the absorber will be depleted and will only be supplied to the proximity by diffusion from longer and longer distances. In various embodiments, absorber 200 absorbs contaminants in any manner that absorber is capable of absorbing when the disks are not spinning.

Absorber 200 is a flow-by filter, as described above. In other words, absorber 200 is a passive absorber which is in contrast to an active absorber (e.g., flow-through absorber). The rate of diffusion and capture of the contaminants is not significantly affected by the velocity of the gas flow generated by the rotating disks, as long as the disks are rotating within the range of rotational speed typical of HDDs.

However, the greater the surface area 215 of absorber 200 (and absorbent 220), the greater the rate of capturing of contaminants by absorber 200. It should be appreciated that the surface area 215 can be any measurement that is conducive and compatible to effectively absorb contaminants within HDD. In one embodiment, surface area 215 is 2.5 centimeters² (cm²) for a 65 millimeter (mm) disk.

Contaminants are vapor born contaminants. In various embodiments, contaminants can be, but are not limited to, organic vapor and/or inorganic gaseous contaminants.

In one embodiment, absorbent 220 includes a thickness (in the direction from surface 250 to top surface 215) of at least 250 microns. In another embodiment absorbent 220 has a thickness in a range from 250 microns to 3000 microns.

In one embodiment, low density gas can be temporarily sealed within HDD. For example, low density gas is temporarily sealed within HDD during a servo-write process. In another embodiment, low density gas is hermetically sealed within HDD.

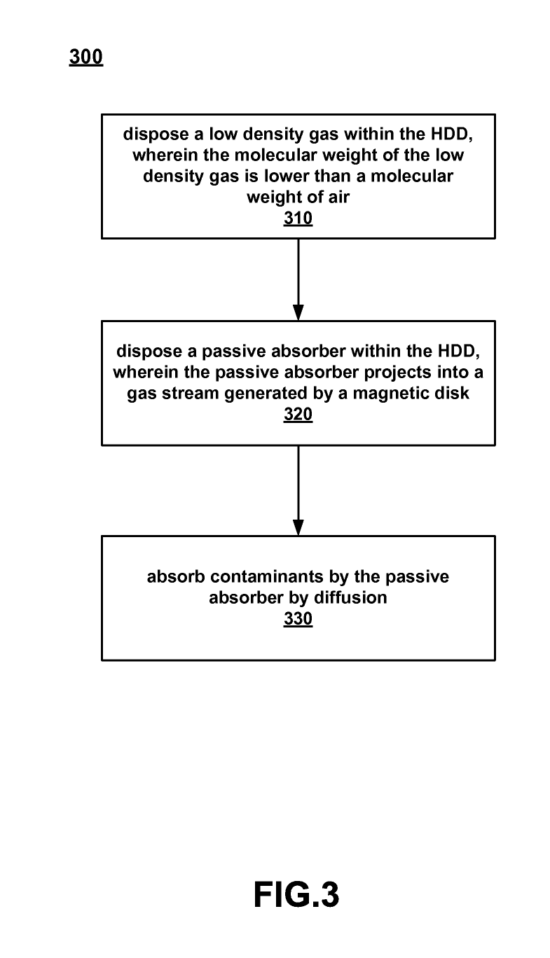

FIG. 3 depicts a method for absorbing contaminants within a low density gas filled hard disk drive (HDD). At step 310, a low density gas is disposed within the HDD. In one embodiment, the molecular weight of the low density gas (e.g., He) is lower than a molecular weight of air.

At step 320, a passive absorber is disposed within the HDD. The passive absorber (e.g. absorber 200) projects into a gas stream generated by a magnetic disk. At step 330, contaminants (e.g., vapor born) are absorbed by the passive absorber by diffusion.

Various embodiments of the present invention are thus described. While the present invention has been described in particular embodiments, it should be appreciated that the present invention should not be construed as limited by such embodiments, but rather construed according to the following claims.

1. A hard disk drive (HDD) comprising:
a magnetic disk;
a low density gas within said HDD; and
an absorber configured to absorb contaminants within said HDD by diffusion.

2. The HDD of claim 1, wherein said low density gas comprises:
a density less than density of air.

3. The HDD of claim 1, wherein said low density gas comprises:
helium.

4. The HDD of claim 1, wherein said low density gas is selected from a group consisting of: helium, neon and hydrogen.

5. The HDD of claim 1, wherein said low density gas is hermetically sealed within said HDD.

6. The HDD of claim 1, wherein said low density gas is not required to be hermetically sealed within said HDD.

7. The HDD of claim 1, wherein said contaminants comprises:
vapor born contaminants.

8. The HDD of claim 1, wherein said contaminants are selected from a group consisting of: inorganic contaminants or organic contaminants.

9. The HDD of claim 1, wherein said absorber comprises:
a passive absorber.

10. The HDD of claim 1, wherein said absorber comprises:
a flow-by absorber.

11. The HDD of claim 1, wherein said absorber projects into a gas stream generated by said disk.

12. The HDD of claim 1, wherein said absorber projects directly into a gas stream generated by said disk.

13. The HDD of claim 1, wherein said HDD does not require a flow-through chemical filter.

14. A method for absorbing contaminants within a low density gas filled hard disk drive (HDD), said method comprising:
disposing a low density gas within said HDD, wherein said molecular weight of said low density gas is lower than a molecular weight of air;
disposing a passive absorber within said HDD, wherein said passive absorber projects into a gas stream generated by a magnetic disk; and
absorbing contaminants by said passive absorber by diffusion.

15. The method of claim 14, wherein said disposing a low density gas within said HDD comprises:
disposing helium within said HDD.

16. The method of claim 14, comprising:
hermetically sealing said low density gas within said HDD.

17. The method of claim 14, wherein said absorbing contaminants comprises:
absorbing vapor born contaminants.

18. The method of claim 14, wherein said disposing a passive absorber within said HDD comprises:
disposing a flow-by absorber within said HDD.

19. The method of claim 14, wherein absorbing contaminants by said passive absorber by diffusion comprises:
absorbing contaminants by said passive absorber by diffusion when said magnetic disk is not rotating.

20. The method of claim 14, wherein said disposing a passive absorber within said HDD, wherein said passive absorber projects into an airstream generated by a magnetic disk comprising:
disposing a passive absorber within said HDD, wherein said passive absorber projects into a gas stream rotating with said magnetic disk.
